(19) United States
(12) Patent Application Publication
(10) Pub. No.: US 2020/0086381 A1
(43) Pub. Date: Mar. 19, 2020

(54) Post-treatment process for increasing the hot strength of a formed part made of particulate material and binder, 3D printing arrangement and formed part

(71) Applicant: ExOne GmbH, Gersthofen (DE)

(72) Inventors: Thomas Leinauer, Diedorf (DE); Lisa Huber, Augsburg (DE); Alexander Connor, Gersthofen (DE); Christoph Hauck, Kühbach (DE); Martin Bednarz, Tandern (DE)

(21) Appl. No.: 16/615,580

(22) PCT Filed: Mar. 19, 2018
(86) PCT No.: PCT/EP2018/056895

§ 371 Date: Nov. 21, 2019

(30) Foreign Application Priority Data
May 23, 2017 (DE) 10 2017 111 266.9

(51) Int. Cl. B22C 9/12; B33Y 10/00; B33Y 70/00; B28B 1/00; B28B 11/24; B22C 1/16; B22C 1/18

(52) U.S. Cl. CPC B22C 9/123; B33Y 10/00; B33Y 70/00; B33Y 80/00; B28B 11/241; B22C 1/162; B22C 1/18; B28B 1/001

(57) ABSTRACT

A post-treatment process for increasing the hot strength of a formed part (100) made of particulate material and binder is disclosed, wherein the formed part (100) is formed a part manufactured by 3D printing (S72) and after its manufacture is heated (S30) using a heating device (40), and the heated formed part (100) is exposed (S50) to an atmosphere enriched with gaseous water generated by supplying water.

The invention relates to a post-treatment process for increasing the hot strength of a formed part made of particulate material and binder, a corresponding 3D printing arrangement and a formed part treated with the process and produced with the 3D printing arrangement, respectively.

A relevant parameter of formed parts is their hot strength. In foundry technology, for example, the hot strength of the formed parts used, i.e. formed parts for casting (e.g. casting cores or casting molds, for example casting mold sections), is an important parameter. If the hot strength of the formed parts used is too low, the formed part may change its shape during the casting process, lose its dimensional stability and/or suffer cracks, which in turn may lead to defective cast parts.

In the case of formed parts made from a particulate material such as sand and a binder which holds together or joins/glues together the particles of the particulate material, hot strength can generally be improved by adding additives such as powder additives. However, the addition of additives is associated with additional costs and effort and is only able to increase the hot strength to a limited extent.

Formed parts for casting, as well as other formed parts, can be produced conventionally, for example by core shooting/blowing, or by a generative manufacturing process in a so-called 3D printing process, for example by means of binder jetting.

In this respect, the applicant has recognized that when using the same particulate material, the same binder and (if available) the same additives, the hot strength of formed parts produced using 3D printing may differ from the hot strength of formed parts produced, for example, by core shooting. One reason for this is presumably the different manufacturing conditions underlying the respective technology. In 3D printing, the formed part is produced by applying unsolidified/loose particulate material in layers and by then selectively solidifying the particulate material with the binder in a respective layer (see, for example, patent applications DE 10 2014 112 447 and DE 10 2009 056 687, the disclosure content of which is included herein by this reference). In core shooting/blowing, on the other hand, the particulate material mixed with the binder is shot/blown into a mold under pressure and at elevated temperature.

In this respect, the inventors of the present application have found that when silicate/water glass is used as binder, the hot strength of 3D-printed formed parts may be significantly reduced compared to that of shot/blown formed parts due to the different manufacturing conditions, which may require the addition of additives and/or the application of a possibly complex curing process of the binder.

EP 2 163 328 A1 discloses a process of producing a formed part of a casting mold for casting molten metal, wherein a core or molding sand comprising a mold base material coated with water glass is filled into a cavity forming the formed part, and wherein the core or molding sand is brought into contact with steam as a hardening agent for curing and solidifying to form the formed part.

Ramakrishnan, Robert “3-D-Drucken mit einem anorganischen Formstoffsystem” (3-D printing with an inorganic molding material system) (dissertation TU Munich) discloses an additive manufacturing process for producing inorganically bound casting molds and casting cores.

It can be regarded as an object of the invention to provide a process and a 3D printing arrangement with which formed parts can be obtained which are made of particulate material and binder and have an increased/appropriate hot strength. It can also be regarded as an object of the invention to provide a formed part with improved hot strength.

To this end, the invention provides a post-treatment process for increasing the hot strength of a formed part made of particulate material and binder as claimed in claim 1, a 3D printing process for producing a formed part made of particulate material and binder in combination with a post-treatment process for increasing the hot strength of a formed part made of particulate material and binder as claimed in claim 15, a 3D printing arrangement as claimed in claim 17 and a formed part as claimed in claim 19. Further embodiments of the invention are described in the dependent claims.

Concretely, the inventors have clearly not turned conventional “adjusting screws”, such as research into new additives or the optimization of known additives, but have broken new ground, namely a post-treatment of the manufactured formed part. This makes it possible to partially or completely dispense with the use of additives, which in turn can lead to numerous advantages (cost savings, process simplification, simple powder/particulate material handling, incl. recycling of the powder, etc.; especially in the case of 3D printing) or to further increase the hot strength beyond the usual level. In doing so, the inventors surprisingly found out that the hot strength can be increased by exposing the formed part and in particular its binder to gaseous water in a heated state. Contrary to possible expectations that a supply of water would not promote the hot strength of the formed part, it was recognized that a supply of and infiltration with gaseous water could lead to a significant increase in the hot strength of formed parts. The proposed post-treatment is, in addition, easy to implement and highly efficient. It is assumed that penetration of the gaseous water into the heated formed part may result in a type of (additional) cross-linking of the binder, which in turn results in an increased hot strength of the formed part.

According to various aspects of the invention, a post-treatment process is provided for increasing the hot strength of a formed part made of particulate material and binder (in other words, a hot strength increase post-treatment process in which the manufactured formed part is subjected to a post-treatment process with the result of increased hot strength in at least a portion thereof), wherein the manufactured formed part is a formed part manufactured by 3D printing and is heated after having been manufactured using a heating device, and the heated formed part is exposed to an atmosphere enriched with gaseous water generated by supplying water.

In order to increase the hot strength, it is in this respect necessary that the formed part is heated and that the heated formed part is exposed to an atmosphere enriched with gaseous water (hereinafter also referred to as “water atmosphere”) generated by supplying water. If the formed part is merely heated without being exposed to an atmosphere enriched with gaseous water generated by supplying water, no noticeable increase in the hot strength of the formed part is achieved.

For example, to expose the heated formed part to an atmosphere enriched with gaseous water generated by supplying water, external water may be supplied, i.e. water that does not originate from the formed part itself, for example from the binder thereof. The (external) water can first be supplied in liquid form, where it then evaporates. For example, liquid water may be supplied by feeding, for example injecting it into the atmosphere (e.g. a heating chamber of the heating device) in a heated state of the atmosphere, and/or liquid water may be arranged in an open container in the atmosphere (e.g. before heating). Alternatively or in addition, the water may already be supplied in gaseous form, for example contained in a gas mixture, for example an air mixture. In the latter case, the gas mixture has, for example, a higher content of gaseous water than the external environment of the heating device (for example, a content increased at least by a factor of 2 or 3 relative to g/m³), so that an enrichment with gaseous water of the atmosphere to which the formed body is to be exposed is possible. An atmosphere enriched with gaseous water can therefore be understood as being an atmosphere whose content of gaseous water is greater than the content of gaseous water in the external environment of the heating device (e.g. content increased by at least a factor of 2 or 3 relative to g/m³). The atmosphere enriched with gaseous water generated by supplying water may therefore comprise external gaseous water resulting from the supply of water and internal gaseous water originating from the formed part itself.

The supply of water may, for example, occur only once or multiple times and/or continuously or in a timed/intermittent way.

For example, direct contact of the formed part with liquid water is excluded or avoided, i.e. reduced to a minimum. If the formed part is exposed to liquid water instead of gaseous water, the formed part may disintegrate.

Heating of the formed part and exposure of the formed part to an atmosphere enriched with gaseous water may, for example, take place in succession or in an overlapping way, partially or completely. The atmosphere enriched with gaseous water may be formed, for example, by/in the heating device or a heating chamber/a heating space thereof, alternatively by/in a separate space, for example a space downstream of the heating space.

The formed part may, for example, be manufactured without the addition of additives. Within the meaning of the application, an additive may be understood as being a substance which is added to the particulate material and/or the binder during manufacture, in order to adjust or increase the hot strength of the formed part. However, the invention does not preclude the use of such an additive, and one or more additives may be used to further increase the hot strength.

According to various aspects of the invention, the formed part may, for example, be a formed part for casting, for example a casting core or a casting mold, for example a casting mold section. The formed part for casting may, for example, be a formed part for metal casting, i.e. a formed part for casting which is used for example for aluminum casting, grey cast iron, malleable cast iron or steel casting. The present invention is particularly useful for a formed part for casting, since the hot strength of the formed parts is of particular importance in foundry technology.

According to various aspects of the invention, the binder may, for example, comprise water glass. The water glass may, for example, be selected from the group consisting of sodium silicate, potassium silicate, lithium silicate and combinations thereof. For example, the binder may comprise at least one (water-soluble) silicate. For example, the binder may comprise a water-soluble alkali silicate, wherein the alkali silicate may, for example, be selected from the group consisting of water-soluble sodium silicate, water-soluble potassium silicate, water-soluble lithium silicate and combinations thereof. The dried/hardened binder may, for example, comprise, silica and/or metasilicate. For example, the water glass may be added to the particulate material in solid or dry form, and water may be applied in a dosed manner to a layer of particulate material and solid binder using a printhead to selectively etch/partly solve the binder. Alternatively, the water glass may be applied in a dosed and selective way to a layer of particulate material in a flowable form, for example in the form of an aqueous solution, by means of a print head. The use of water glass can be advantageous as it is an environmentally friendly binder compared to other binders and, for example, does not produce any harmful, hazardous vapors/emissions during casting. In addition, the present invention is of particular importance here as well, given that the provision of a functional hot strength can be demanding, especially when water glass is used, especially when the formed part is being printed.

According to various aspects of the invention, the particulate material may, for example, contain sand particles. Sand particles may be understood as being naturally occurring and/or synthetically produced particles of inorganic material with a particle size of 0.063 mm to 2 mm. For example, the sand particles may be selected from the group consisting of quartz sand particles, alumina sand particles, aluminum silicate sand particles, zircon sand particles, olivine sand particles, silicate sand particles, chromite sand particles and combinations thereof. For example, the sand particles may have an average particle size of 90 to 250 μm, for example 90 to 200 μm, for example 110 to 180 μm.

According to various aspects of the invention, the formed part may, for example, be a formed part manufactured by means of binder jetting. Alternatively, the formed part may be a part manufactured by another generative manufacturing process. Binder jetting is an additive production process in which a flowable binder (e.g. water glass or an aqueous solution thereof) or a flowable binder precursor or a flowable binder component (e.g. water in the case of solid water glass being added to the particulate material) is selectively applied to an unsolidified particulate material layer by means of a printing device, e.g. a print head, in order to selectively bond or glue or solidify the particles of the particulate material, in order to manufacture a formed part layer by layer. Suitable processes and devices for manufacturing the formed part in 3D printing are described, for example, in patent applications DE 10 2014 112 447 and DE 10 2009 056 687, the disclosure content of which is incorporated by this reference. Here, too, the present invention comes into play, since, as explained at the beginning, in the case of 3D printing different hot strengths are observed compared to conventional processes, for example when using water glass as a binder. In 3D printing, complicated formed parts can be manufactured easily and in a cost-effective way. Compared to other additive manufacturing processes, such as laser sintering, formed parts can be manufactured faster using binder jetting and the equipment used is less complex, which is why binder jetting is cheaper than other additive manufacturing processes.

According to various aspects of the invention, the formed part may, for example, be embedded in a bulk of loose particulate material after its manufacture, which may, for example, be received together with the formed part (or a plurality of formed parts) in a building box, and may be unpacked from the bulk before the formed part is heated. Suitable methods for unpacking the formed part are described, for example, in patent applications DE 10 2012 106 141 and DE 10 2014 112 446, the disclosure content of which is incorporated by this reference. In the simplest case, the formed part may be removed from the bulk for unpacking by hand and may thus be separated from unsolidified particulate material. Unpacking before heating allows the post-treatment process to be carried out efficiently in order to increase the hot strength, although it is conceivable to make the entire bulk material including the formed part accessible for the post-treatment process. For example, by unpacking the formed part before heating the formed part or before feeding the formed part to the heating device, the post-treatment process for increasing the hot strength may be carried out faster and in a more cost-effective way, given that only the formed part itself needs to be heated, not the particulate material bulk surrounding the formed part, and the formed part may also easily and effectively be exposed to gaseous water. In addition, the heating device may correspondingly dimensioned to be smaller.

Alternatively or in addition, a hardening of the binder (and thus a hardening of the formed part), for example thermal hardening, may be carried out in the post-treatment process in accordance with the invention before heating the formed part. For example, in a post-treatment process, hardening may be carried out before and/or after unpacking following manufacture of the formed part, for example hardening before unpacking using a microwave device, for which purpose, for example, the building box may be placed in the microwave device together with the bulk material. Alternatively or in addition, a repeated hardening (e.g. in layers) may be carried out during the manufacture of the formed part (“in-machine” process), e.g. by means of infrared radiation. Hardening can increase the green part strength or, if necessary, the removal strength of the formed part, which may be advantageous, for example, with complex or heavy formed parts. However, the hardening step is optional according to the invention and therefore not absolutely necessary, since the manufactured formed part may already exhibit sufficient green part strength even without a separate hardening process (e.g. in the case of printing of water glass solution as a result of an optimized adjustment of viscosity and similar measures). After application/passing through the treatment process according to the invention, the binder (and thus also the formed part) may have at least the same hardness as after hardening using the microwave device, even if the latter has not been carried out, so that the post-treatment process according to the invention can, for example, save hardening using a microwave device. The post-treatment process according to the invention can therefore, for example, be carried out without an intermediate post-process for hardening the formed part, and can thus, for example, immediately follow the manufacturing process (3D printing process, possibly including unpacking).

According to various aspects of the invention, the hot strength (e.g. hot bending strength) of the treated formed part (i.e. of the formed part subjected to the post-treatment process according to the invention), compared to the original hot strength (before the invention post-treatment process is carried out), may be increased by at least 30%, for example by at least 40%, for example by at least 50%, for example by at least 60%, for example by at least 70%, for example by at least 80%, for example by at least 90%, for example by at least 100%, for example by at least 150%, for example by at least 200%, for example by up to 500%. To determine the respective hot strength (before and after the post-treatment process according to the invention), for example, a measurement can be carried out as described below. For example, in the case of a complex formed part for casting, it is possible to make a test specimen of the same material as the actual formed part and with the same manufacturing process as for the actual formed part for the measurement of the respective hot strength, and then to subject the test specimen to the same post-treatment(s) (including the post-treatment process for increasing the hot strength according to the invention) under the same conditions. The respective measurement can then be made on the test specimen and can be added to the formed part for the calculation of the hot strength increase. Alternatively or in addition, the respective hot strength may also be determined, for example, on the formed part itself, for example qualitatively on the basis of its dimensional accuracy and/or in the case of core breakage.

According to various aspects of the invention, the heated formed part may be exposed in the atmosphere enriched with gaseous water to gaseous water for example such that the formed part is infiltrated in at least a portion thereof by the gaseous water and as a result of the infiltration the hot strength is increased in at least that portion (for example primarily/substantially only in that portion), for example by modifying the binder, for example by changing the polymer configuration of the binder. The portion may, for example, include or be a rim zone of the formed part (i.e. an outer edge area), for example a rim zone with a depth of at least 250 μm, for example at least 500 μm, for example at least 1 mm, for example at least 5 mm, for example at least 1 cm, for example at least 2 cm. The term rim zone or its depth refers to an area of the formed part that extends from a surface of the formed part orthogonally to the surface into the formed part. The inventors have found that it may be sufficient to increase the hot strength (at least primarily) only in a rim zone of the formed part, in order to prevent the formed part from changing its shape, losing dimensional its stability and/or cracking during the casting process.

For example, according to various aspects of the invention, the heating device may be selected from the group consisting of a continuous furnace, a convection furnace, a convector oven, a hot air furnace and combinations thereof. For example, the heating device may have a heating space in which the formed part can be received/accommodated. The heating device may, for example, comprise a water supply device, for example in the form of one or more injection nozzles, through which liquid and/or gaseous water can be injected into the heating chamber. Alternatively or in addition, the heating device may, for example, comprise a container located in the heating space, which can receive liquid water or in which liquid water is received/accommodated. For example, the heating device may also comprise one or more sensors, for example a temperature sensor to determine the temperature in the heating space and/or a humidity sensor to determine the humidity in the heating space, i.e. the content of gaseous water in the heating space atmosphere. The heating device may also comprise a controller which controls the water supply device in a way to feed water into the heating space for a predetermined period of time (see below), e.g. by taking into account the temperature and/or humidity determined by the sensors. The heating device may, for example, be a device that is separate from a 3D printer and the above-mentioned optional microwave device, which may be arranged, for example, adjacent thereto and may be connected to the 3D printer and/or the microwave device by means of a transport system, for example a driverless transport system.

According to various aspects of the invention, the heated formed part may, for example, be fed to a heating space of a heating device after its manufacture (see above) and may be heated using the heating device. For example, the heating space may be a closed heating space. For example, the heated formed part may be exposed to the atmosphere enriched with gaseous water in the heating device, for example by feeding water into the heating space of the heating device in which the formed part is received/accommodated/is to be received/accommodated. As mentioned above, the water may be supplied to the heating space in liquid and/or gaseous form, for example by means of any one of the processes/devices described above. In other words, for example, heating and exposing to a water atmosphere may be carried out in a common or in the same heating space, allowing a simple post-treatment process. This means that the water atmosphere may be a heating space atmosphere or may be formed in the heating space. For example, the heating space atmosphere in a heated state may be supplied with liquid water by means of the water supply device, so that it is evaporated due to the heated state in the heating space and can thus contribute to the formation of the water atmosphere.

According to various aspects of the invention, the heated formed part may, for example, be exposed for a predetermined period of at least 30 seconds to the atmosphere enriched with gaseous water generated by supplying water, for example at least 45 seconds, for example at least 60 seconds, for example at least 2 minutes, for example at least 3 minutes, for example at least 4 minutes, for example at least 5 minutes. This lower limit may vary depending on the size of the formed part and/or the hot strength requirement and/or the desired depth of the above rim zone. However, with these values determined in trials, a satisfactory result could be achieved in each case. For example, an upper limit for the predetermined time period may be set at 60 minutes, for example 45 minutes, for example 30 minutes, and the values indicated for the lower limit and the upper limit may be combined as desired. During the predetermined time period, it is possible, for example, to maintain the temperature/minimum temperature and/or gaseous water content specified below, for example over the entire time period, for example over at least 95% of the time period, for example over at least 90% of the time period, for example over at least 85% of the time period, for example over at least 80% of the time period.

According to various aspects of the invention, the formed part or at least a portion thereof (e.g. the above rim zone) may be heated to a temperature of greater than or equal to 150° C., for example of greater than or equal to 175° C., for example of greater than or equal to 200° C., for example of greater than or equal to 225° C., for example of greater than or equal to 250° C. The minimum temperature also depends on various factors, but with the values given, appropriate results could be obtained. For example, an appropriate maximum temperature may be given as 350° C., for example 300° C., and the values given for the minimum temperature and the maximum temperature may be combined as required. For example, an exemplary range may be given as 260-280° C.

According to various aspects of the invention, to heat the formed part, for example, the heating device or the heating space thereof may be heated to a (furnace) temperature of greater than or equal to 150° C., for example of greater than or equal to 175° C., for example of greater than or equal to 200° C., for example of greater than or equal to 225° C., for example of greater than or equal to 250° C. For example, a maximum (furnace) temperature may be specified as 350° C., for example 300° C.; in this respect, the values specified for the minimum temperature and the maximum temperature may be combined as desired. For example, an exemplary range may be specified as 260-280° C. For example, the heating device or its heating space may first be heated to the above-mentioned temperature, and then the atmosphere in the heating device or in the heating space thereof may be enriched with gaseous water by supplying water.

According to various aspects of the invention, the atmosphere enriched with gaseous water generated by supplying water may, for example, have a gaseous water content of greater than or equal to 50 g/m³, for example of greater than or equal to 60 g/m³, for example of greater than or equal to 70 g/m³, for example of greater than or equal to 80 g/m³, for example of greater than or equal to 90 g/m³, for example of greater than or equal to 100 g/m³, for example of greater than or equal to 125 g/m³, for example of greater than or equal to 150 g/m³, for example of greater than or equal to 175 g/m³, for example of greater than or equal to 200 g/m³, for example of greater than or equal to 300 g/m³, for example of greater than or equal to 400 g/m³, for example of greater than or equal to 500 g/m³, for example of greater than or equal to 600 g/m³. For example, the atmosphere may be saturated with gaseous water at the temperature specified above, for example oversaturated, or the gaseous water content may be selected/set in such a way that the atmosphere is saturated with gaseous water at 100° C., for example oversaturated. The minimum content also depends on various factors, such as the dwell time of the formed part in the heating device.

According to various aspects of the invention, a 3D printing process is provided for manufacturing a formed part from particulate material and binder in combination with a post-treatment process for increasing the hot strength of a formed part manufactured from particulate material and binder, which may be configured as described above and which follows (directly or indirectly) the process of producing the formed part. For example, the 3D printing process of manufacturing a formed part from particulate material and binder may be a binder jetting process (see above). Suitable 3D printing processes for manufacturing a formed part from particulate material and binder are described, for example, in patent applications DE 10 2014 112 447 and DE 10 2009 056 687, the disclosure content of which is incorporated by this reference. A binder suitable for use in the manufacturing process is, for example, water glass (see above), which in the case of a binder jetting process, may be applied, for example in aqueous solution by means of a print head in a dosed manner and selectively to a partial region of a previously applied layer of unsolidified particulate material. Optionally, the layer of loose/unsolidified particulate material may contain an additive which reduces/prevents creeping/penetrating of the selectively printed water glass (from the partial region).

According to various aspects of the invention, any one of the above-mentioned processes may be carried out in combination with a process/step of casting metal, for example aluminum or an alloy thereof using the formed part, which follows the post-treatment process for increasing the hot strength of the formed part (directly or indirectly). The casting may, for example, be an engine block, but is of course not limited thereto.

According to various aspects of the invention, a 3D printing arrangement is provided to perform any one of the above processes, the 3D printing arrangement comprising a 3D printer and a heating device. The heating device may be configured as described above, i.e. may comprise a heating space arranged to receive/accommodate a formed part manufactured by means of the 3D printer and a water supply device configured to supply gaseous water to the heating space (for example before and/or after receiving/accommodating the formed part in the heating space). For example, the 3D printer may comprise a building platform (which may, for example, be included in a building box), a coating device (so-called recoater) and a printing device with a print head. Suitable 3D printers are, for example, described in patent applications DE 10 2014 112 447 and DE 10 2009 056 687, the disclosure content of which is incorporated by this reference. The 3D printer and the heating device may, for example, be arranged to be adjacent to each other and/or may be connected to each other by a transport system as described above. According to various aspects of the invention, the 3D printing arrangement may also include, for example, a controller configured to control the water supply device in a way to feed water into the heating space for a predetermined period of time. For example, the controller may be configured to control the supply device in a way to supply a predetermined amount of water into the heating space. The controller may, for example, be coupled to an injection nozzle to control the same, for example to control an open state and a closed state of the injection nozzle. The controller may, for example, be configured to control the temperature in the heating space. In the heating space, for example, a temperature sensor may be arranged which is coupled to the controller and which is arranged to determine the temperature in the heating space. In the heating space, for example, a humidity sensor may be arranged which is coupled to the controller and which is configured to determine the content of gaseous water (and the absolute air humidity, respectively) in the heating space.

According to various aspects of the invention, a formed part is provided which has been (post) treated and/or manufactured by any one of the above-described processes, or manufactured by means of any one of the above-described 3D printing arrangements, and thus has an increased hot strength in at least a rim zone/shell thereof.

Exemplary but non-restrictive embodiments of the present invention are shown in the Figures and are explained in more detail below.

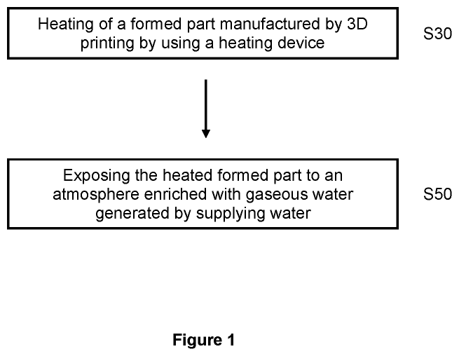

FIG. 1 illustrates a post-treatment process for increasing the hot strength of a formed part made of particulate material and binder according to a first embodiment of the invention.

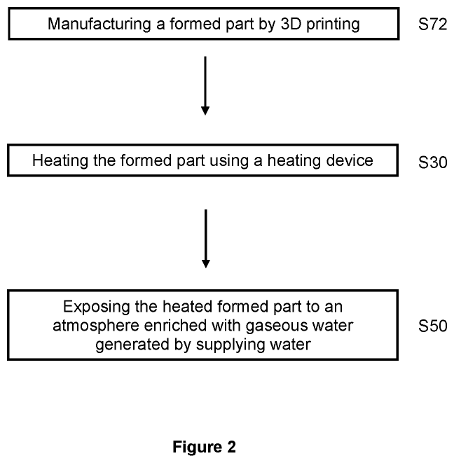

FIG. 2 illustrates a post-treatment process for increasing the hot strength of a formed part made of particulate material and binder according to a second embodiment of the invention.

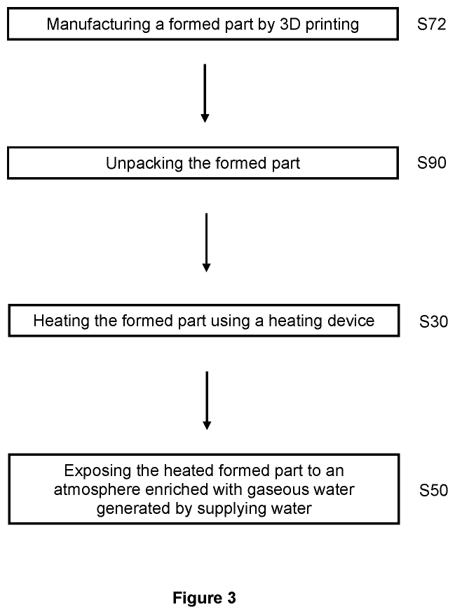

FIG. 3 illustrates a post-treatment process for increasing the hot strength of a formed part made of particulate material and binder according to a third embodiment of the invention.

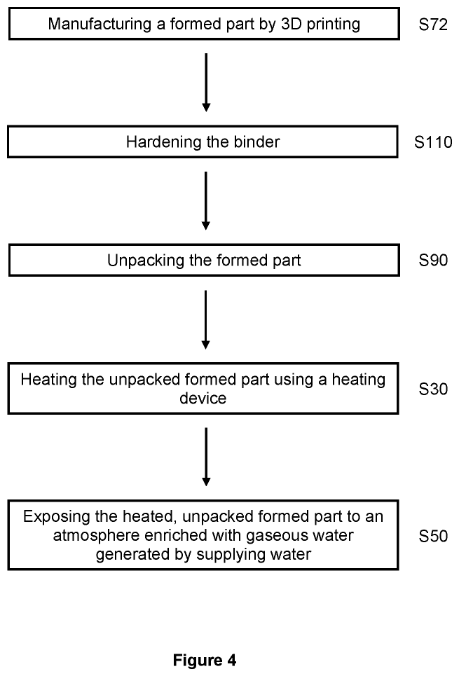

FIG. 4 illustrates a post-treatment process for increasing the hot strength of a formed part made of particulate material and binder according to a fourth embodiment of the invention.

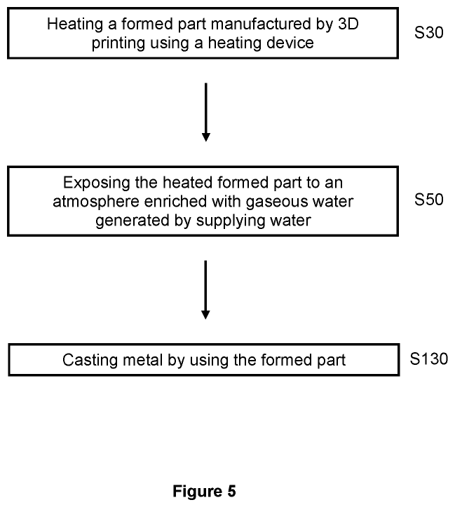

FIG. 5 illustrates a post-treatment process for increasing the hot strength of a formed part made of particulate material and binder in combination with a process/step of casting metal according to a fifth embodiment of the invention.

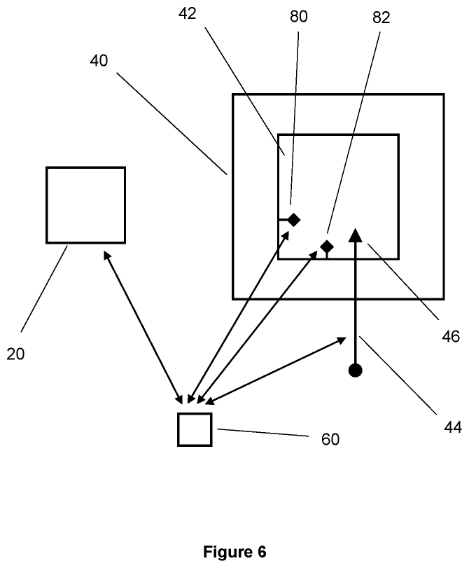

FIG. 6 illustrates a simplified, schematic view of a 3D printing arrangement according to a sixth embodiment of the invention.

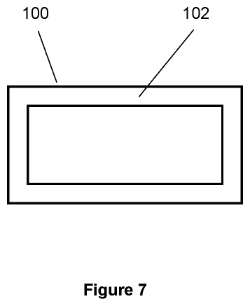

FIG. 7 illustrates a simplified schematic view of a formed part according to a seventh embodiment of the invention.

In the following detailed description, reference is made to the attached Figures which form part thereof and in which specific embodiments are shown for illustration, in accordance with which the invention may be carried out.

It shall be understood that other embodiments may be used and that structural or logical changes may be made without departing from the scope of protection of the present invention. It shall be understood that the features of the various exemplary embodiments and aspects described herein may be combined unless specifically stated otherwise. The following detailed description should therefore not be construed in a restrictive sense, and the scope of protection of the present invention is defined by the attached claims.

Within the scope of this description, terms such as “connected”, “joined” and “coupled” may be used to describe both a direct and an indirect connection and a direct or indirect coupling.

In the Figures, identical or similar elements shall be provided with identical reference signs where appropriate.

As shown in FIGS. 1-5, in a post-treatment process for increasing the hot strength (hereinafter also referred to as “process for increasing the hot strength”) of a formed part 100 made of particulate material and binder, in accordance with the various embodiments of the invention, the formed part 100 produced by 3D printing is heated after its manufacture using a heating device 40 (step S30) and the heated formed part 100 is exposed to an atmosphere enriched with gaseous water generated by supplying water (step S50). The various embodiments of the invention thus indicate processes for the treatment and post-treatment, respectively, of manufactured formed parts 100.

The formed part 100 may be a formed part for casting, for example a casting core or a casting mold or a casting mold section. The particulate material from which the formed part 100 is made may contain sand particles. The sand particles may be selected from the group consisting of quartz sand particles, alumina sand particles, aluminum silicate sand particles, zircon sand particles, olivine sand particles, silicate sand particles, chromite sand particles and combinations thereof. The binder from which the formed part 100 is made may, for example, comprise water glass respectively silicate, for example sodium water glass respectively sodium silicate. The binder may bond or glue the particles of the particulate material and may thus hold them together.

The formed part 100 is a formed part 100 manufactured by 3D printing (see step S72 in FIGS. 2 to 4). For example, the formed part 100 may be a formed part 100 manufactured by binder jetting. The formed part 100 may, for example, be manufactured by means of a process described in patent applications DE 10 2014 112 447 and DE 10 2009 056 687, the disclosure content of which is incorporated herein by this reference. In this respect, for example, water glass may be applied or printed onto a layer of the unsolidified particulate material by means of a print head of a 3D printer.

After its manufacture by 3D printing, the formed part 100 may be embedded in a bulk material made of loose particulate material, which, for example, is received/accommodated in a building box together with the formed part 100, and may be unpacked from the bulk material before feeding the formed part 100 to the heating device 40 (see step S90 in FIGS. 3 and 4). Optionally, a hardening of the binder may be carried out before unpacking the formed part 100 (see step S110 in FIG. 4). Hardening may, for example, be carried out using a microwave device. Alternatively or in addition, repeated hardening, for example thermal hardening, may be carried out during the manufacture of the formed part 100.

According to the various embodiments of the invention, the heated formed part 100 may be exposed to gaseous water in the atmosphere enriched with gaseous water in such a way that the formed part 100 is infiltrated by the gaseous water in at least one portion thereof and the hot strength in at least that portion is increased as a result of the infiltration, for example by modifying the binder in that portion, for example by changing the polymer configuration of the binder. The portion may comprise a rim zone 102 of the formed part 100 (see FIG. 7), for example a rim zone 102 with a depth of at least 250 μm.

The heating device 40 used in the process may be any suitable heating device, e.g. a continuous furnace, a convection furnace, a convector, a hot air furnace or combinations thereof. The heated formed part 100 may, for example, be exposed to the atmosphere enriched with gaseous water in the heating device 40, for example by supplying (liquid and/or gaseous) water to a heating space 42 of the heating device 40 in which the formed part 100 is received/accommodated/is to be received/accommodated. For example, the heated formed part 100 may be exposed to the atmosphere enriched with gaseous water in the heating device 40 by supplying or placing an open container containing liquid water in the heating space 42. Alternatively or in addition, the heated formed part 100 may be exposed to the atmosphere enriched with gaseous water in the heating device 40 by feeding liquid water into the heating space 42 by means of a suitable device, e.g. an injection nozzle.

In the process, the formed part 100 or at least a portion thereof may, for example, be heated to a temperature of at least 150° C., and the heated formed part 100 may be exposed in the process, for example for a predetermined period of time (for example, at least 30 seconds) to the atmosphere enriched with gaseous water generated by supplying water, having, for example, a gaseous water content of greater than or equal to 50 g/m³.

According to various embodiments of the invention, the hot strength of the treated formed part 100 may be increased by at least 30% as compared to the original hot strength (i.e. as compared to the hot strength of the untreated formed part).

The process described above for increasing the hot strength may be followed by a process/step of casting metal, for example aluminum or an alloy thereof, using the formed part 100 (see step S130 in FIG. 5).

As shown in FIG. 6, a 3D printing arrangement according to embodiments of the invention comprises a 3D printer 20 and a heating device 40 having a heating space 42 configured to receive/accommodate a formed part 100 manufactured by means of the 3D printer 20 and a water supply device 44 configured to supply gaseous water to the heating space 42. The 3D printer 20 may, for example, be configured as described in patent applications DE 10 2014 112 447 and DE 10 2009 056 687, the disclosure content of which is incorporated herein by this reference, and may include, for example, a building box with a building platform, a coating device and a print head. The heating device 40 may be configured as described above. The water supply device 44 may, for example, comprise an injection nozzle 46 which may, for example, be configured to supply gaseous and/or liquid water to the heating space 42.

The 3D printing arrangement may further include a controller 60 configured to control the water supply device 44 to supply water to the heating space 42 for a predetermined period of time. The controller 60 may, for example, be coupled to the injection nozzle 46 of the supply device 44 to control the same, for example to control an open state and a closed state of the injection nozzle 46. The controller 60 may, for example, be arranged to control the temperature in the heating space 42. In the heating space 42, a temperature sensor 80 may, for example, be arranged which is coupled to the controller 60 and which is configured to determine the temperature in the heating space 42. For example, a humidity sensor 82 may be arranged in the heating space 42, which is coupled to the controller 60 and which is configured to determine the content of gaseous water (and the absolute air humidity, respectively) in the heating space 42.

### Test Example

In the following, a test example from a series of tests carried out by the applicant to verify the invention is illustrated.

Table 1 shows the relative hot strengths of different test specimens. All test specimens were manufactured from the same material (with the exception that test specimens 1, 3 and 4 did not contain any hot strength enhancing additive) with the same manufacturing process and treated with the same post-treatment (if applicable). For this purpose, the test specimens were manufactured by means of binder jetting using quartz sand as particulate material and sodium silicate as binder (printed as an aqueous solution), and had a dimension of 172 mm×22.4 mm×8 mm (“HDT test bar”, HDT: Hot Deformation Test). After the test specimens had been manufactured by 3D printing, the test specimens were unpacked and then immediately subjected to a process according to the invention for increasing the hot strength (except for test specimens 1 and 2). A separate hardening was not carried out.

As shown by Table 1, no additive for enhancing hot strength was added to the first test specimen and the test specimen was not treated with the process according to the invention. An additive to improve hot strength was added to the second test specimen, and the test specimen was not treated with the process according to the invention. No hot strength additive for enhancing hot strength was added to the third and fourth test specimens and the test specimens were treated with the process according to the invention. An additive to improve hot strength was added to the fifth and sixth test specimens, and the test specimens were treated with the process according to the invention. The fourth test specimen is a reproduction of the third test specimen, and the sixth test specimen is a reproduction of the fifth test specimen.

The hot strength was determined using the “HOT-FLEX, Hot Deformation Tester” of “BENETLAB”. In order to determine the hot strength, the test specimen was clamped in the test device, a distance meter with test weight (mass: 26.02 g) was placed on the test specimen, the test specimen was heated from below by means of a gas flame (temperature: approx. 1,200° C.; on the test device, a fuel gas flow of 5×10⁻⁸ L/h and an air flow of 13 L/h may, for example, be set) and the deflection of the test specimen was measured over time. From the elapsed time until a given deflection downwards (e.g. of 2 mm) was reached, the relative hot strengths below were determined. The relative hot strength of the first test specimen was set to 1. The relative hot strengths of the other test specimens were determined by dividing the elapsed time of a corresponding test specimen by that of test specimen 1. The results are shown in Table 1.

TABLE 1

| Test | | Treatment of | Relative |
|---|---|---|---|
| specimen | Additive¹ | test specimen² | hot strength |
| 1 | − | − | 1.0 |
| 2 | + | − | 1.5 |
| 3 | − | + | 2.1 |
| 4 | − | + | 2.1 |
| 5 | + | + | 2.0 |
| 6 | + | + | 2.2 |

¹0.5% by mass of a powder additive was added to the sand to increase the hot strength.
²A convection furnace was heated to 260-280° C.; then liquid water was injected into the furnace (about 100 ml); then the test specimen was introduced into the furnace and left in the furnace for 20 minutes, with liquid water being injected at regular intervals.

A comparison of the first test specimen with the third and fourth test specimens shows that the process according to the invention is able to increase the hot strength of a treated formed part 100, to which no additive is added to increase the hot strength, by more than 100% compared to the original hot strength of the formed part 100. A comparison of the second test specimen with the fifth and sixth test specimens shows that the process according to the invention is able to increase the hot strength of a treated formed part 100, to which an additive is added to increase the hot strength, by approximately 40% compared to the original hot strength of the formed part 100. This means that the process according to the invention is also able to increase the hot strength of formed parts 100 to which an additive is added to increase the hot strength.

The comparison of the third and fourth test specimens with the fifth and sixth test specimens also shows that in the present examples the addition of an additive can be omitted, if the process according to the invention is used.

The previous description of specific exemplary embodiments of the present invention was presented for the purpose of illustration and description. It is not intended to be exhaustive or to limit the invention to the disclosed precise forms, and it is self-evident that many modifications and variations are possible in the light of the above teaching. The exemplary embodiments have been selected and described to explain certain principles of the invention and its practical application in order to enable a person skilled in the art to manufacture and apply various exemplary embodiments of the present invention as well as various alternatives and modifications thereof. It is intended that the scope of the invention be defined by the claims attached hereto and their equivalents.

1-19. (canceled)

20. A 3D printing process comprising the steps of:
(a) producing a formed part (100) from a particulate material and a binder within a bed of the particulate material in which the particulate material is loose;
(b) removing the formed part (100) from the bed;
(c) heating the formed part (100) using a heating device (40);
(d) supplying external water to generate an atmosphere enriched with gaseous water;
(e) exposing the heated formed part (100) during step (c) to the atmosphere enriched with gaseous water;
wherein the hot strength of the formed part (100) is increased during step (e).

21. The process of claim 20 wherein the formed part (100) is a casting core or a casting mold or a casting mold section.

22. The process of claim 20 wherein the binder comprises a water glass.

23. The process of claim 20 wherein the particulate material is selected from the group consisting of quartz sand particles, alumina sand particles, aluminum silicate sand particles, zircon sand particles, olivine sand particles, silicate sand particles, chromite sand particles and combinations thereof.

24. The process of claim 20 wherein step (a) comprises three-dimensional printing the formed part (100).

25. The process of claim 20 wherein step (a) includes hardening the binder using a microwave device.

26. The process of claim 20 further comprising a step of hardening the binder using a microwave device prior to step (b).

27. The process of claim 20 wherein the hot strength of the formed part (100) is increased by at least 30% as a result of step (e).

28. The process of claim 20 wherein during step (e) at least a portion of the formed part (100) is infiltrated by the gaseous water and as a result of the infiltration the hot strength in at least said portion is increased by modifying the binder in said portion.

29. The process of claim 28 wherein the portion comprises a rim zone (102) of the formed part (100) having a depth of at least 250 μm.

30. The process of claim 20 wherein the heating device (40) is selected from the group consisting of a continuous furnace, a convection furnace, a convector, a hot air furnace, and combinations thereof.

31. The process of claim 20 wherein step (e) is performed in a heating space (42) of the heating device (40).

32. The process of claim 20 wherein during step (e) the formed part (100) is exposed for a predetermined period of at least 30 seconds to the atmosphere enriched with gaseous water.

33. The process of claim 20 wherein during step (c) at least a portion of the formed part (100) is heated to a temperature of greater than or equal to 150° C.

34. The process of claim 20 wherein the atmosphere enriched with gaseous water has a content of gaseous water which is greater than or equal to 50 g/m³.

35. The process of claim 20 further comprising a step of casting metal into the formed part (100) after step (e).

36. A device comprising:
a 3D printer (20);
a heating device (40) having a heating space (42) configured to accommodate a formed part (100) manufactured by means of the 3D printer (20); and
a water supply device (44) configured to supply external water to the heating space (42);
wherein the heating device (40) is adapted to create a gaseous water enriched atmosphere in the heating space (42) from the external water.

37. The device of claim 36 further comprising a controller (60) configured to drive the water supply device (44) to supply the external water to the heating space (42) for a predetermined period of time.
